(19) United States
(12) Patent Application Publication
(10) Pub. No.: US 2014/0005945 A1
(43) Pub. Date: Jan. 2, 2014

(54) Method For Estimation Of Borehole And Formation Properties From Nuclear Logging Measurements

(71) Applicants: Vivek Anand, Houston, TX (US); Robert Freedman, Houston, TX (US); Tong Zhou, Sugar Land, TX (US); David Rose, Sugar Land, TX (US); Sicco Beekman, Houston, TX (US)

(72) Inventors: Vivek Anand, Houston, TX (US); Robert Freedman, Houston, TX (US); Tong Zhou, Sugar Land, TX (US); David Rose, Sugar Land, TX (US); Sicco Beekman, Houston, TX (US)

(73) Assignee: SCHLUMBERGER TECHNOLOGY CORPORATION, Sugar Land, TX (US)

(21) Appl. No.: 13/992,751

(22) PCT Filed: Dec. 9, 2011
(86) PCT No.: PCT/US11/64062

§ 371 Date: Jul. 30, 2013

Related U.S. Application Data
(60) Provisional application No. 61/421,694, filed on Dec. 10, 2010.

(51) Int. Cl. G01V 5/10

(52) U.S. Cl. CPC G01V 5/102
USPC 702/8

(57) ABSTRACT

Disclosed is a model-independent method for accurate prediction of formation and borehole properties from neutron capture cross section measurements. A mapping function is constructed which maps the input measurements to the properties of interest. The mapping function is a linear combination of Gauss radial basis functions. The expansion coefficients and widths of the Gaussian functions are determined uniquely using a database populated with representative samples. For a sample not included in the original database, the desired properties can be estimated from the mapping function using the measurements made on the unknown sample.

### BACKGROUND

Determination of formation properties such as porosity and oil saturation is crucial for reservoir management and evaluation. For example, time lapsed measurements of reservoir oil and water saturations are used for monitoring reservoir depletion, planning enhanced oil recoveries and diagnosing production problems such as water breakthrough. Nuclear logging tools such as Schlumberger's Reservoir Saturation Tool (RST) are routinely used to estimate formation properties. This is particularly true for cased wells in which resistivity tools cannot be used for measurement of oil saturation.

The nuclear logging tools determine formation oil saturation indirectly by measuring the neutron capture cross section (Σ) of the formation. When the formation salinity is high enough, an anomalously low sigma provides the hydrocarbon signature. The measurement of Σ is based on the following physical phenomenon. A burst of high energy neutrons at 14 MeV generated using a pulsed neutron generator is send into the formation. The neutrons interact inelastically and elastically with the nuclei in the borehole and the formation. The energy of the neutrons is lost at each interaction. The neutrons continue to lose energy till they reach the thermal energy level of 0.025 eV. The thermal neutrons are subsequently absorbed by the nuclei. The absorption leads to the emission of gamma rays that are detected by crystal detectors located on the tool. The count rate of the emitted gamma rays is measured as a function of time. The decrease in the production rate of the gamma rays is proportional to the absorption rate of thermal neutrons. This decay is approximately exponential in nature. Σ is inferred from the slope of a semi-log plot of gamma rays versus time.

The measured exponential decay includes contributions from the formation as well as the borehole. To differentiate the two contributions, a dual-burst pattern is exercised in which a short burst of neutrons is followed by a long burst. The count rate of the capture gamma rays is measured using two detectors located at different positions with respect to the neutron source. Due to the proximity of the near detector with the source, the measurements are influenced by the borehole environment and hence borehole sigma—especially for the short burst neutron burst measurement. In contrast, the far detector measurements are influenced by formation sigma—especially the long neutron burst measurement. Finally, sigma measurements are affected by neutron diffusion and environmental variables related to borehole, casing, cement and formation. These environmental variables can include borehole size, casing size, casing weight, borehole fluid salinity, porosity and lithology.

Four capture cross-sections can be obtained from the decay rates measured by the two detectors following the short and long neutron bursts. These cross sections include sigma borehole near apparent (SBNA), sigma formation near apparent (SFNA), sigma borehole far apparent (SBFA), and sigma formation far apparent (SFFA). These quantities are called “apparent” because they need to be corrected for the environmental effects to estimate the true formation sigma. In addition, formation porosity and borehole salinity can also be estimated from the capture cross sections after making appropriate environmental corrections. In mathematical terminology, the measured cross sections and the environmental parameters are the “independent variables” from which the formation and borehole properties, called the dependent variables, can be predicted.

The causal relationship between the independent and dependent variables is complex and unknown. Hence, simple analytical models cannot be used to accurately describe the underlying relationship. The required transforms between the independent and dependent variables may be derived using a database based approach. A database was populated with laboratory measurements made with nuclear logging tools using several borehole and lithology combinations. Measurements were done with varying borehole and casing sizes, cement thickness and borehole salinity. For each case, measurements were made with rocks of different lithologies and porosities. Additionally, measurements were done with rocks saturated with different salinity fluids to incorporate a wide range of downhole conditions. In total, more than 3000 measurements were included in the database.

The dependent variables can be expressed as a first or second order expansion of the independent variables as shown below,

BSAL=b₀ [symbol] [symbol] +b₁ [symbol] [symbol] SBNAb₂ [symbol] [symbol] TRAT²+b₃ [symbol] [symbol] SFFA+b₄ [symbol] [symbol] CID+b₅ [symbol] [symbol] T_{Csg}+b₆ [symbol] [symbol] T_{cem}+ (1)

TPHI=b₀ [symbol] [symbol] +b₁ [symbol] [symbol] TRATb₂ [symbol] [symbol] TRAT²+b₃ [symbol] [symbol] BSAL+b₄ [symbol] [symbol] SFFA+b₅ [symbol] [symbol] CID+b₆T_{Csg}+b₇ [symbol] [symbol] T_{cem}+ (2)

SIGM=b₀^{T}+b₁^{T}SFFA+b₂^{T}TPHI+b₃^{T}BSAL+b₄^{T}CID+b₅^{T}T_{Csg}+b₆^{T}T_{cem}+ (3)

where BSAL, TPHI and SIGM are borehole salinity, porosity and formation sigma respectively. The environmental variables including casing ID, cement thickness and casing thickness are denoted by CID, Tcem and Tcsg respectively. The unknown expansion coefficients b's are determined using the database measurements. Given the large size of the database, Eqs. (1)-(3) represent an overdetermined set of many hundred equations with approximately a half-dozen unknowns. The coefficients can be determined using classical weighted linear multiple regression (WLMR) analysis. The WMLR method involves assignment of an appropriate weight to each of the database points to weigh those points close to the measured data-point heavily while weighing lightly those distant points.

There are three flaws with this methodology:

Polynomial model—the technique proposes that the dependent variables can be estimated from a first or second order expansion of the independent variables. However, the dependence is usually more complex than this assumption allows for, and can be highly non-linear. Using a polynomial model can lead to poor accuracy of the estimates.

Arbitrary choice of the weighting matrix—The technique weights the database points according to the proximity with the measured data point. The points that are close to the unknown sample are weighted heavily in comparison to those that are distant. The choice of the weights is, however, arbitrary and can lead to uncertainties in the estimates.

Poor generalization—the WLMR method is limited by the poor generalization capability of the polynomial functions. That is, outside the range of parameters in the database, the predictions of the polynomial functions can be poor.

There is a need for a model-independent technique for estimating accurate answers from nuclear logging measurements. There is also a need for the technique for generalization properties outside the range of parameters in the database.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In various embodiments, methods and systems are disclosed for prediction of formation and borehole properties from neutron capture cross section measurements made by a nuclear logging tool. The method includes constructing a mapping function which maps input measurements from a nuclear logging tool to one or more properties of interest. The mapping function is a linear combination of Gauss radial basis functions, and represents a smooth and continuous non-linear functional relationship. The method also includes determining at least a expansion coefficient and a width of each the Gaussian functions using a database populated with a plurality of representative samples of neutron capture cross section measurements. In various embodiments, a physical relationship between the input measurements and the formation and borehole properties is stored in a database.

### BRIEF DESCRIPTION OF THE DRAWINGS

Embodiments of this disclosure are described with reference to the following figures. The same numbers are used throughout the figures to reference like features and components. A better understanding of the methods or apparatuses can be had when the following detailed description of the several embodiments is considered in conjunction with the following drawings, in which:

FIG. 1 is a block diagram of a pulsed neutron logging tool that may be used to locate hydrocarbon in a formation.

FIG. 2 shows a plot of Measured Formation Sigma against Predicted Simulated Sigma in units of (cu).

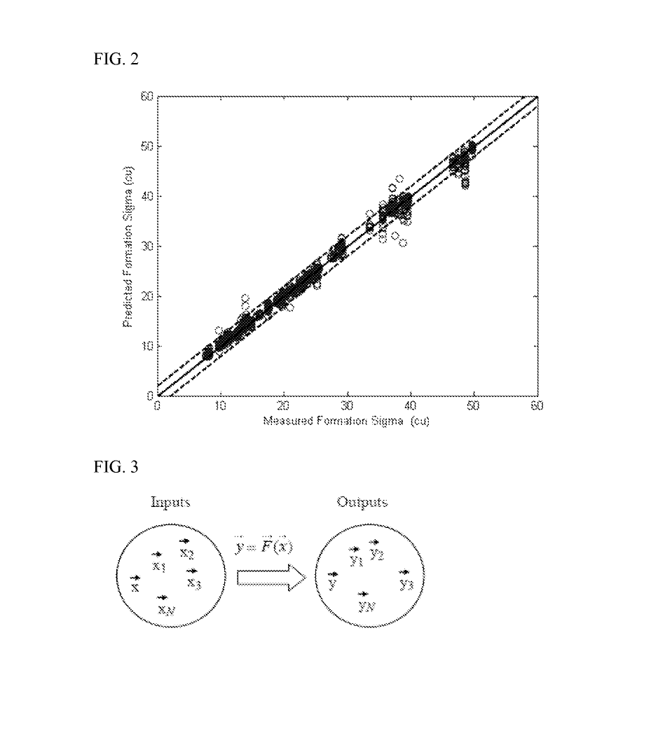

FIG. 3 shows a pictorial representation of the mapping function method with the inputs mapped into outputs using a mapping function F̅ which is a linear combination of radial basis functions.

FIGS. 4 through 6 show the comparison of predicted formation sigma, borehole salinity, and porosity, respectively. with the corresponding measured quantities.

FIG. 7 shows a block diagram of a computer system by which methods disclosed can be implemented.

### DETAILED DESCRIPTION

In the following description, numerous details are set forth to provide an understanding of the present disclosure. However, it will be understood by those skilled in the art that the present disclosure may be practiced without these details and that numerous variations or modifications from the described embodiments are possible.

A model-independent technique is presented for quantitative and accurate estimation of formation and borehole properties from nuclear logging measurements. This technique assumes that the physical relationship between the measurements and the properties of interest is contained in a laboratory database. This database can be obtained in the laboratory with different formation/borehole conditions. The database can also be synthesized from numerical modeling which takes into account the response of the tool in addition to the interactions of the neutrons with nuclei in the formation and the borehole. For each experimental condition (called the sample), the database is divided into inputs and outputs. The inputs contain all the measurements and the environmental variables while the outputs contain the properties that need to be predicted.

Using the database an analytical interpolation or mapping function is constructed that maps the database inputs for each sample to the corresponding database outputs. The mapping function is a linear combination of non-linear functions called radial basis functions (RBF). The mapping function parameters can be uniquely determined from the database measurements. Once the mapping function is constructed it can be used to predict properties for samples not included in the database.

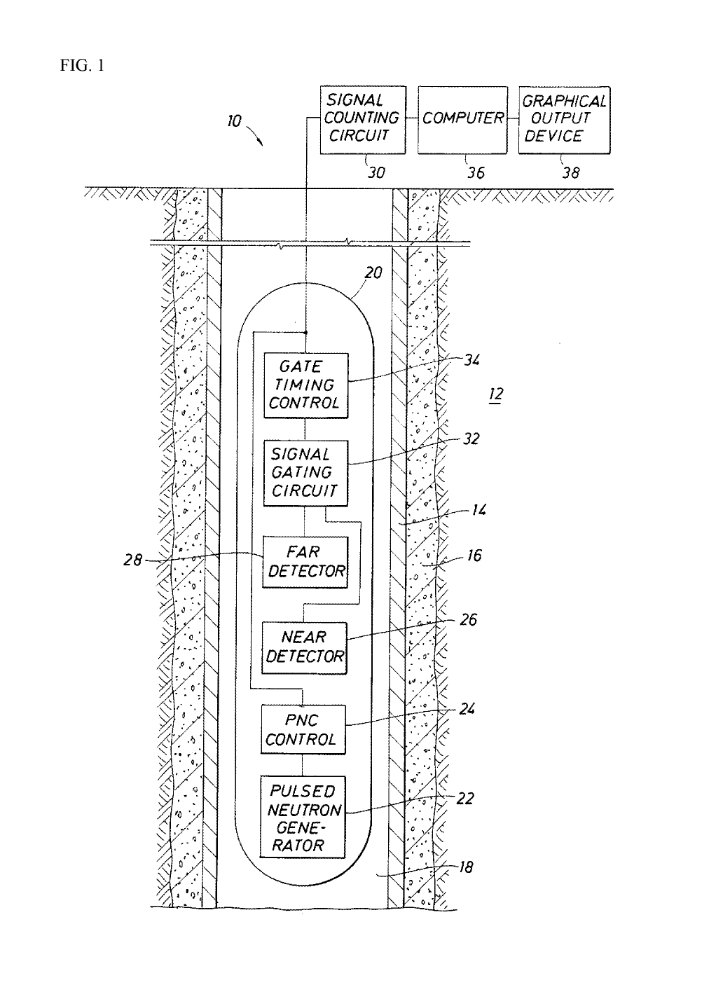

The determinations described above can be performed using data acquired using a logging tool such as that shown in FIG. 1, for example, which may be selected as a Reservoir Saturation Tool™ (“RST”) used in logging services commercially available from Schlumberger Oilfield Services. Pulsed neutron capture (PNC) logging tools have been used for years to evaluate the presence of hydrocarbon gas behind well casings in bypassed formations. PNC tools operate under the theory that neutrons generated by the tools and traveling with sufficient energy will interact with surrounding atoms to produce energy in at least two different ways. First, a high-energy neutron will collide “inelastically” with a nucleus, exciting the nucleus and causing the nucleus to release a gamma ray. Second, the same neutron eventually will lose enough energy that it will reach a “thermal” state and will be “captured” by another atomic nucleus, which in turn will release a gamma ray of capture.

Referring to FIG. 1, a well-logging system 10 (or well-logging “tool”) may be used to locate hydrocarbon reservoirs in portions of a subsurface formation 12 located behind the casing 14 and cement 16 of a well bore 18. A PNC neutron burst tool 20 travels through the well bore 18, measuring the effects of high-energy neutrons on atomic nuclei in the surrounding formation and in the “borehole,” which can additionally include the casing 14, the cement 16 and any fluid within the well bore 18 for this purpose. A pulsed neutron generator 22 in the tool 20 produces high-energy neutrons in response to signals from a PNC control circuit 24. The neutron generator 22 emits the neutrons in discrete bursts at an energy level (14 MeV) high enough to allow the neutrons to collide inelastically with and impart energy to surrounding atomic nuclei. The neutron generator may be like those described in U.S. Pat. No. 2,991,364, issued to C. Goodman on Jul. 4, 1961, and in U.S. Pat. No. 3,546,512, issued to A. H. Frentrop on Dec. 8, 1970.

As discussed above, inelastic collisions between neutrons and atomic nuclei cause the affected nuclei to release gamma rays, most of which are detected by at least two gamma radiation detectors 26, 28 in the PNC tool 20. Each detector 26, 28 generates an output signal when it detects a gamma ray. The actual positions of the detectors 26, 28 depend upon the characteristics of the PNC tool 20. The detectors 26, 28 also produce output signals upon detecting gamma rays released when the neutrons, slowed to the thermal state by inelastic collisions, are captured by atomic nuclei surrounding the PNC tool 20, as discussed above.

Signals produced by the detectors 26, 28 are delivered to a signal counting circuit 30 during prescribed time periods, known as count “gates.” A signal gating circuit 32, which operates under the control of a gate timing control circuit 34, defines the count gates and therefore controls the flow of signals from the detectors 26, 28 to the signal counting circuit 30. The signal counting circuit 30 counts the gamma rays received by each detector during each count gate and provides the counts to a computer 36. The computer 36 stores the count information and uses it to generate a curve indicating whether and where hydrocarbon may be located in the formation 12, as discussed below. The computer 36 displays the curve on a graphical output device 38, such as a CRT, a printer, a plotter, or a recorder.

The mathematical formulation of the interpolation technique used to predict values for the types of measurements obtained by the tool 20 is described as follows. Let f̅( x̅), x̅∈ [symbol] [symbol] [symbol] and f̅∈ [symbol] [symbol] [symbol] be a real-valued vector function of n variables, and let values of be given at N distinct points, X̅ᵢ̅. The interpolation problem is to construct the function F̅( x̅) that approximates f̅( x̅) and satisfies the interpolation equations:

F̅( x̅ᵢ̅)= y̅ᵢ̅, i=1,2 . . . N (4)

The interpolation function is constructed as a linear combination of RBFs given as

$$\overline{F} ( {\overline{x}}_{l} ) = \text{?} \vert \overline{x} - {\overline{x}}_{l} \vert , i = 1 , 2 … N \\ \text{?} \text{indicates text missing or illegible when filed} \qquad ( 5 )$$

The functions φ∥ x̅− x̅ᵢ̅∥ are called “radial” because the argument of the function depends only on the distance between, not the direction, of x, from an arbitrary input vector at which the function is to be evaluated. The argument is given by the Euclidean norm in the n-dimensional hyper space. The coefficients can be calculated by requiring that the interpolation equations are satisfied exactly. Thus, the coefficients are given as

C=Φ⁻¹·Y (6)

where C is the matrix whose rows consist of the coefficient vectors i.e.

$$C = [ \begin{matrix}{c}_{1 , 1} & {c}_{1 , 2} & … & c \text{?} \\ {c}_{2 , 1} & {c}_{2 , 2} & … & {c}_{2} \text{?} \\ … & … & … & … \\ … & … & … & … \\ {c}_{N , 1} & {c}_{N , 2} & … & {c}_{N} \text{?}\end{matrix} ] \\ \text{?} \text{indicates text missing or illegible when filed} \qquad ( 7 )$$

The matrices Y and Φ are the N×N and N×m matrices containing the RBF and data vectors given as

$$\begin{matrix} Φ = [ \begin{matrix}{ϕ}_{1 , 1} & {ϕ}_{1 , 2} & … & {ϕ}_{1 , N} \\ {ϕ}_{2 , 1} & {ϕ}_{2 , 2} & … & {ϕ}_{2 , N} \\ … & … & … & … \\ … & … & … & … \\ {ϕ}_{N , 1} & {ϕ}_{N , 2} & … & {ϕ}_{N , N}\end{matrix} ] & ( 8 ) \\ Y = [ \begin{matrix}{y}_{1 , 1} & {y}_{1 , 2} & … & {y}_{1} \text{?} \\ {y}_{2 , 1} & {y}_{2 , 2} & … & {y}_{2} \text{?} \\ … & … & … & … \\ … & … & … & … \\ {y}_{N , 1} & {y}_{N , 2} & … & {y}_{N} \text{?}\end{matrix} ] \\ \text{?} \text{indicates text missing or illegible when filed} & ( 9 )\end{matrix}$$

It can be proved mathematically that the matrix Φ is non-singular for certain functional forms of RBFs including Gaussian, multiquadric, and inverse quadrics. This property ensures that the mapping function of Eq. (5) is unique. The RBFs used in this disclosure are the normalized Gaussian RBFs given as

$$ϕ ‖ \text{?} - \text{?} ‖ = \frac{exp ( - \frac{{‖ \text{?} - \text{?} ‖}^{2}}{2 {s}_{j}^{2}} )}{{\sum }_{j = 1}^{N} exp ( - \frac{{‖ \text{?} - \text{?} ‖}^{2}}{2 {s}_{j}^{2}} )} \\ \text{?} \text{indicates text missing or illegible when filed} \qquad ( 10 )$$

It is understood that non-Gaussian functions can also be used. Hence, using a database with N samples, a mapping function that is consistent with the measurements can be uniquely defined from Eq. (5). For an unknown sample not included in the database, the desired output [symbol] [symbol] can be obtained by evaluating the mapping function at the corresponding input ē e.

[symbol]

[symbol]

= F̅( x̅). (11)

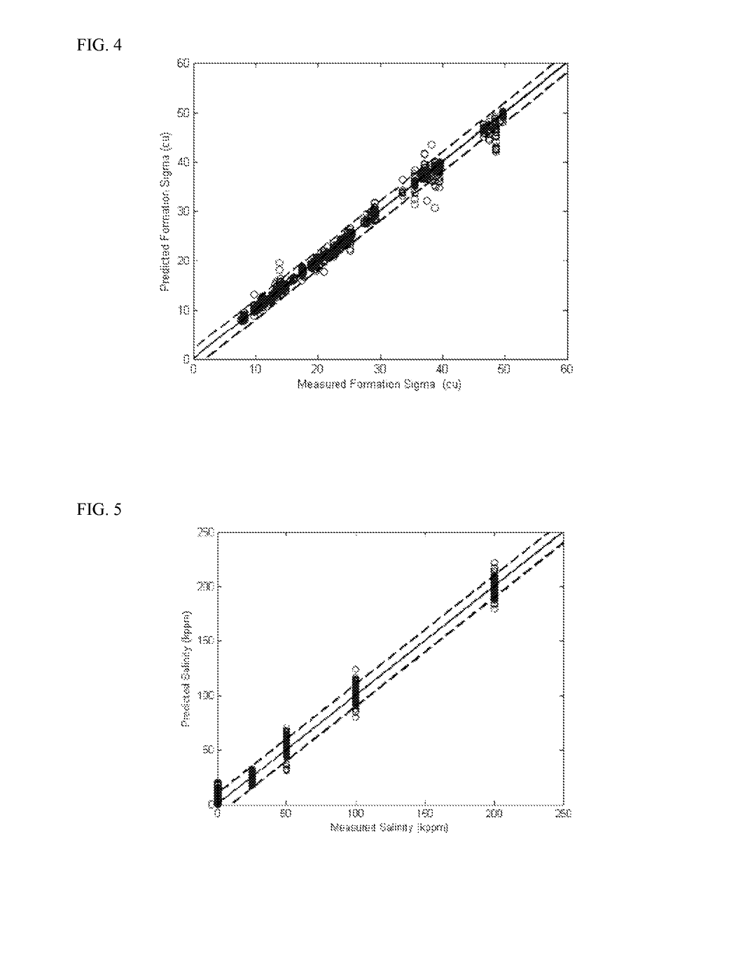

The high level implementation of the method is shown pictorially in FIG. 3. The database inputs ( x̅₁̅, x̅₂̅ . . . ) are mapped to the corresponding database outputs ( y̅₁̅, y̅₁̅ . . . ) using a function F̅( x̅). The mapping function is a linear combination of RBFs. The expansion coefficients are uniquely determined such that the interpolation equations (4) are exactly satisfied for the N samples in the database. The output [symbol] [symbol] for a sample [symbol] [symbol] not included in the database can be calculated using the mapping function with known coefficients.

A database was acquired at the Schlumberger Environmental Effects Calibration Facility (EECF) in Houston, Tex. Measurements were made with three nuclear logging tools. These measurements were obtained in thirty different neutron tank formations with varying formation and borehole fluid salinities. Three different formation lithologies including sandstone, limestone and dolomite were used for measurements. In addition, different casing and cement completions were inserted in the borehole to simulate cased holes. Table 1 shows the summary of the database measurements. The measurements are described in detail in SPE 30598.

| Hole | Casing | | | | | |
|---|---|---|---|---|---|---|
| size | Size | Weight | | | Formation flush³ | Borehole Fluid⁴ |
| (in.) | (in.) | (lbm/ft) | Lithology¹ | Porosity² | (kppm NaCl) | (kppm NaCl) |
| 6 | Open Hole | | L S D | Z* M H | 0 70 140 210 | 0 25 50 100 200 Air |
| 6 | 4.5 | 10.5 | L S D | Z* M H | 0 70 140 210 | 0 25 50 100 200 Air |
| 6 | 5.0 | 18 | L S D | Z* M H | 0 70 140 210 | 0 25 50 100 200 Air |
| 8 | Open Hole | | L S D | Z* M H | 0 70 140 210 | 0 25 50 100 200 Air |
| 8 | 5.5 | 15.5 | L S D | Z* M H | 0 70 140 210 | 0 25 50 100 200 Air |
| 8 | 7.0 | 32 | L S D | Z* M H | 0 70 140 210 | 0 25 50 100 200 Air |
| 10 | 5.5 | 15.5 | L S D | Z M H | 0 70 140 210 | 0 25 50 100 200 Air |
| 10 | 7.0 | 32 | L S D | Z M H | 0 70 140 210 | 0 25 50 100 200 Air |
| 10 | 7.625 | 26.4 | L S D | Z M H | 0 70 140 210 | 0 25 50 100 200 Air |
| 12 | 7.625 | 26.4 | L S | Z* M H | 0 70 140 210 | 0 25 50 100 200 Air |
| 12 | 9.625 | 32.3 | L S | Z* M H | 0 70 140 210 | 0 25 50 100 200 Air |
| 12 | 9.625 | 53.5 | L S | Z* M H | 0 70 140 210 | 0 25 50 100 200 Air |

¹L = Limestone S = Sandstone D = Dolomite
²Z = zero (0 p.u.) M = medium (15 to 20 p.u.) H = high (33 p.u. for sand, 38 to 43 p.u. in lime and dolomite)
³For sand the 70 and 210 kppm points are modeled, for dolomite 70 and 210 kppm are omitted.
⁴For sand the 25 and 100 kppm points are modeled, for dolomite 25 and 100 kppm are omitted.
*These 0 p.u. points are modeled for sand.

The properties of interest include formation sigma, formation porosity and borehole salinity. The inputs for the prediction of the three quantities are different for the open and cased hole conditions. For the two cases, the inputs include the following: 1. Open Hole—count ratio (TRAT), sigma borehole near apparent (SBNA), sigma formation near apparent (SFNA), sigma borehole far apparent (SBFA), sigma formation far apparent (SFFA), borehole size (BS) and borehole fluid sigma (BFSIG); and 2. Cased Hole—TRAT, SBNA, SFNA, SBFA, SFFA, casing ID (CID), casing thickness (TCSG), cement thickness (TCEM) and BFSIG.

From the mathematical formulation of the previous section, the outputs can be expressed as a linear combination of RBFs as shown below

$$\overline{o} = \frac{{\sum }_{j = 1}^{N} {\overline{c}}_{j} exp ( - \frac{{\vert \vert \overline{A} - \overline{{A}_{j}} \vert \vert}^{2}}{2 {s}_{j}^{2}} )}{{\sum }_{j = 1}^{N} exp ( - \frac{{\vert \vert \overline{A} - \overline{{A}_{j}} \vert \vert}^{2}}{2 {s}_{j}^{2}} )} \qquad ( 12 )$$

In the above equation N is the number of samples in the database, Ā is the input vector given as

Ā=Ā(TRAT, SRNA, SFNA, SBFA, SFFA, BS, BFSIG . . . ) for open hole (13)

Ā=Ā(TRAT, SBNA, SFNA, SBFA, SFFA, BFSIG, CID, TCSG, Tcem . . . ) for cased hole (14)

The output vector, Ō, contains the properties to be predicted given as

Ō=Ō(BSAL, TPHI, FSIG, FSAL . . . ) (15)

The parameters c̅ are obtained from the database using Eq (6). A different mapping function is derived for each database case based on lithology (sandstone, limestone and dolomite), borehole type (open and cased) and borehole fluid type (brine or air). In addition, the database needs to be partitioned into low and high porosity samples. Thus, there are 24 different mapping functions in total.

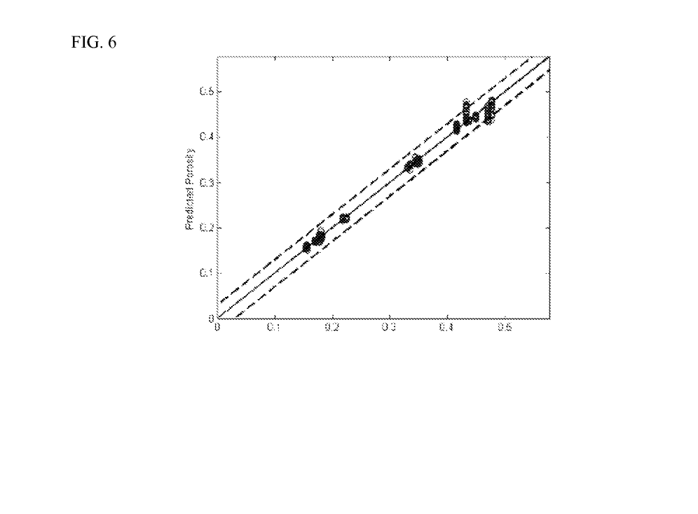

FIGS. 4 to 6 show the comparison of predicted formation sigma, borehole salinity, and porosity with the corresponding measured quantities. The dashed lines correspond to deviation of +/−2 cu for formation sigma, +/−5 kppm for salinity and +/−0.03 pu for porosity. The leave one out method was used for the predictions. In this method, one sample is sequentially removed from the database. The mapping function is obtained from the remaining samples, and subsequently the outputs for the removed sample are predicted using the mapping function. The procedure is repeated for all samples in the database. The average absolute deviations for the three quantities are:

1. BSAL—3.8 kppm

2. TPHI—0.18 pu (RSTA)

3. SIGM—0.44 cu (RSTA)

FIG. 4 shows a plot of measured sigma against predicted sigma for over 1600 data samples in units of cu. For FIG. 4, predicted sigma values were computed for over 1600 data samples, in units of cu. The solid line is a best-fit line and dashed lines correspond to a deviation of +/−2 cu. For FIG. 5, measured values of borehole salinity are ploted against predicted values for salinity in units of kppm. The solid line shows a best-fit line to the data, and the dashed lines correspond to a deviation of +/−3 kppm. For FIG. 6, a plot is shown of measured porosity against predicted porosity in units of pu. The solid line is a best-fit line and the dashed lines correspond to a deviation of +/−0.03 pu.

The model-independent approach has a number of advantages over the prior art. First, there is no need to construct an approximate equation or model. The mapping function representation is general and can represent any smooth and continuous non-linear functional relationship. The mapping function does not merely memorize the database input and output measurements. It is the best approximation to the underlying functional relationship between the database input and output measurements and it provides accurate predictions for samples not in the database. Another advantage of the mapping function approach is that it is easy to include many different types of auxiliary measurements as inputs.

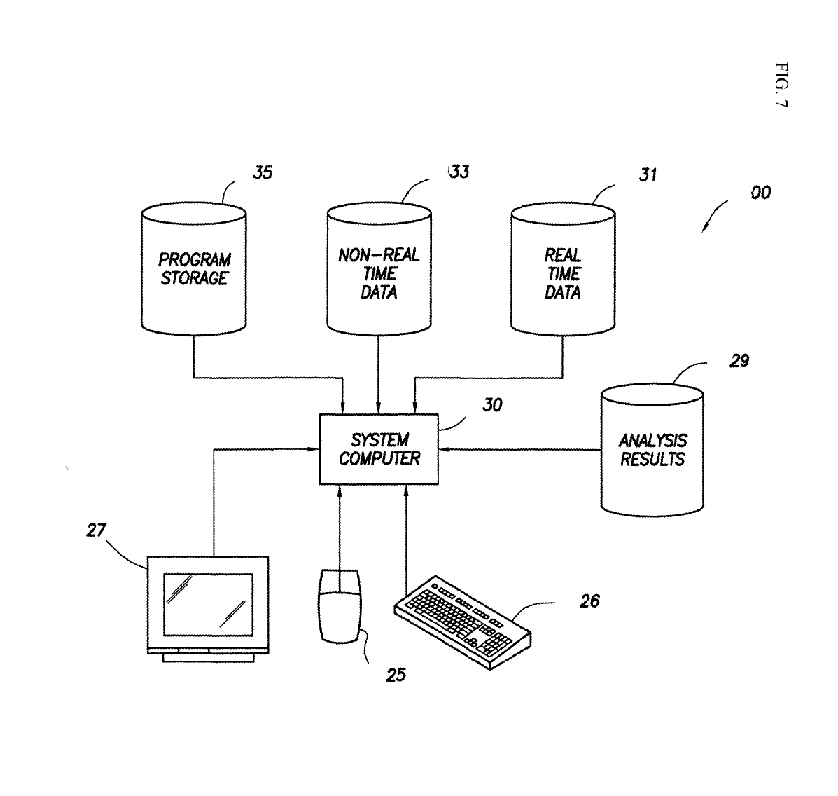

As those with skill in the art will understand, one or more of the steps of methods discussed above may be combined and/or the order of some operations may be changed. Further, some operations in methods may be combined with aspects of other example embodiments disclosed herein, and/or the order of some operations may be changed. It is important to recognize that the process of measurement, its interpretation and actions taken by operators may be done in an iterative fashion; this concept is applicable to the methods discussed herein. Finally, portions of methods may be performed by any suitable techniques, including on an automated or semi-automated basis on computing system 700 in FIG. 7.

Portions of methods described above are typically implemented in a computer system 700, one of which is shown in FIG. 7. The system computer 730 may be in communication with disk storage devices 729, 731, 733 and 735, which may be external hard disk storage devices and measurement sensors (not shown). It is contemplated that disk storage devices 729, 731, 733 and 735 are conventional hard disk drives, and as such, may be implemented by way of a local area network or by remote access. While disk storage devices are illustrated as separate devices, a single disk storage device may be used to store any and all of the program instructions, measurement data, and results as desired.

In one implementation, petroleum real-time data from the sensors may be stored in disk storage device 731. Various non-real-time data from different sources may be stored in disk storage device 733. The system computer 730 may retrieve the appropriate data from the disk storage devices 731 or 733 to process data according to program instructions that correspond to implementations of various techniques described herein. The program instructions may be written in a computer programming language, such as C++, Java and the like. The program instructions may be stored in a computer-readable medium, such as program disk storage device 735. Such computer-readable media may include computer storage media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the system computer 730. Combinations of any of the above may also be included within the scope of computer readable media.

In one implementation, the system computer 730 may present output primarily onto graphics display 727, or alternatively via a printer (not shown). The output from computer 730 may also be used to control instruments within the steam injection operation. The system computer 730 may store the results of the methods described above on disk storage 729, for later use and further analysis. The keyboard 726 and the pointing device (e.g., a mouse, trackball, or the like) 725 may be provided with the system computer 730 to enable interactive operation.

The system computer 730 may be located on-site near the well or at a data center remote from the field. The system computer 730 may be in communication with equipment on site to receive data of various measurements. Such data, after conventional formatting and other initial processing, may be stored by the system computer 730 as digital data in the disk storage 731 or 733 for subsequent retrieval and processing in the manner described above. While FIG. 7 illustrates the disk storage, e.g. 731 as directly connected to the system computer 730, it is also contemplated that the disk storage device may be accessible through a local area network or by remote access. Furthermore, while disk storage devices 729, 731 are illustrated as separate devices for storing input petroleum data and analysis results, the disk storage devices 729, 731 may be implemented within a single disk drive (either together with or separately from program disk storage device 733), or in any other conventional manner as will be fully understood by one of skill in the art having reference to this specification.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A model-independent method for accurate prediction of formation and borehole properties from neutron capture cross section measurements made by a nuclear logging tool, comprising:
obtaining a plurality of neutron capture cross section measurements with the nuclear logging tool;
characterized in that:
constructing a mapping function which maps input measurements to one or more properties of interest, wherein the mapping function comprises a linear combination of Gauss radial basis functions; and
determining at least a expansion coefficient and a width of each the Gaussian functions using a database populated with the plurality of neutron capture cross section measurements.

2. The method of claim 1, wherein mapping function represents a smooth and continuous non-linear functional relationship.

3. The method of claim 1 or 2, wherein a physical relationship between the input measurements and the formation and borehole properties is stored in a database.

4. The method of claim 3, wherein the database is populated with information relating to a plurality of formation and borehole conditions.

5. The method of claim 3 or 4, wherein the database is populated with information synthesized from numerical modeling which takes into account a measurement response of the nuclear logging tool in addition to interactions of neutrons emitted by the nuclear logging tool with nuclei in the formation and the borehole.

6. The method of claims 1 through 5, wherein the properties of interest comprise one or more of formation sigma, borehole salinity, and porosity.

7. The method of claims 1 through 6, further comprising generating at least one predicted value of the property of interest for which the database does not contain a measured value.

8. A system for accurate prediction of formation and borehole properties from neutron capture cross section measurements made by a nuclear logging tool, comprising:
a nuclear logging tool that emits neutrons and performs neutron capture cross section measurements;
a data storage that stores executable instructions, and a database populated with a plurality of representative neutron capture cross section measurements made by the nuclear logging tool;
characterized in that:
a processor that, upon executing the executable instructions stored in the data storage, is configured to:
construct a mapping function that maps input measurements to one or more properties of interest, wherein the mapping function comprises a linear combination of Gauss radial basis functions; and
determine at least a expansion coefficient and a width of each the Gaussian functions using a database populated with a plurality of representative samples of neutron capture cross section measurements; and
generate at least one predicted value of the property of interest for which the database does not contain a measured value; and
an output interface configured to output the at least one predicted value of the property of interest for which the database does not contain a measured value.

9. The system of claim 8, wherein the mapping function represents a smooth and continuous non-linear functional relationship.

10. The system of claim 8 or 9, wherein a physical relationship between the input measurements and the formation and borehole properties is stored in a database.

11. The system of claim 10, wherein the database is populated with information relating to a plurality of formation and borehole conditions.

12. The system of claim 10, wherein the database is populated with information synthesized from numerical modeling which takes into account a measurement response of the nuclear logging tool in addition to interactions of neutrons emitted by the nuclear logging tool with nuclei in the formation and the borehole.

13. The system of claims 8 through 12, wherein the properties of interest comprise one or more of formation sigma, borehole salinity, and porosity.
